(19) United States
(12) Patent Application Publication
(10) Pub. No.: US 2006/0252405 A1
(43) Pub. Date: Nov. 9, 2006

(54) Method and apparatus for filtering of interference signals

(75) Inventors: John E. Matz, Hanover Park, IL (US); Richard Douglas Illman, St. Charles, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/429,740

(22) Filed: May 8, 2006

Related U.S. Application Data
(60) Provisional application No. 60/678,382, filed on May 7, 2005.

(51) Int. Cl. H04M 9/00

(52) U.S. Cl. 455/402

(57) ABSTRACT

A method and apparatus for filtering interference signals to and from a broadband over power line system. The apparatus includes fixed notch filters and adaptive notch filters that filter interference signals that are generated and received by the system. The fixed filters are used for known interference signals, and the adaptive notch filters are used to filter unknown interference signals that are detected over time. The notch filters are configured at both a bridge and client of the system that send and receive broadband signals.

### FIELD OF THE INVENTION

The present invention relates generally to filters, and more particularly, to filters in broadband over power line communications systems where the filters reduce known and unknown interference signal levels generated and received by the system.

### BACKGROUND

Broadband over Power Line (BPL) is the delivery of broadband Internet and communications signals using electrical wiring to conduct high-speed digital signals to homes and businesses. BPL systems are designed to deliver Internet services using medium voltage power lines as the distribution medium and generally use the frequency range between 1.7 and 80 megahertz (MHz).

Because power lines are not designed to prevent radiation of RF energy, BPL may cause interference signals for other radio services that are provided in and around the frequency range of the BPL signal. Power lines and residential wiring may act as antennas that unintentionally radiate the broadband signals as radio signals. From a regulatory standpoint, BPL emits RF energy that is overseen by various regulatory bodies. Accordingly, BPL systems need to be cognizant that they should not create interference to radio services. At the same time, however, BPL systems are not necessarily protected from the interference signals that are brought into the BPL system from external sources. Such external sources include, but are not limited to, the power lines and FCC licensed transmitters. The interference received by the power lines acting as an antenna can overload the BPL system and cause a loss of data and other problems.

Filters may be used to reduce unneeded and unwanted portions of a signal. There are many different types of filters that can be used in a system such as a BPL system like the one described. One of these filter types are notch filters. Notch filters are used in many different applications to attenuate undesired frequencies within signals. Notch filters are designed to reduce RF signals and allow other signals to pass without being effected.

Notch filters come in a variety of different variations and forms that can be used for different purposes and that achieve different results. Fixed notch filters are set to a given frequency and filter the signals at that frequency. Tunable notch filters are similar to fixed notch filters as they are set to a given frequency, but tunable notch filters have a range of frequencies that they can be set to and then fixed at that frequency. Adaptive notch filters are used when the characteristics of a signal are variable in frequency and depend on events over time. Accordingly, adaptive notch filters automatically adjust their frequency response depending upon the circumstances.

Therefore, there is a need for the use of filters with a BPL system such that the interference signals generated by the BPL system are filtered out so as not to provide those signals outside the BPL system. It is also needed for the filters to filter out the signals that are received by the BPL system. The concept and application of bi-directional notch filtering is critical to avoiding interference with user frequencies licensed by authorized agencies and regulatory bodies.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a BPL system that is formed in accordance with some embodiments of the invention.

FIG. 2 is an example of a BPL system that includes multiple notch filters in accordance with some embodiments of invention.

FIG. 3 is an example of multiple notch filters in accordance with some embodiments of the invention.

FIG. 4 is a diagram of the effect of the notch filters in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to filters that are used to reduce interference signals in a broadband over power line system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a filter to reduce interference signals in a broadband over power line system described herein. The non-processor circuits may include, but are not limited to, a radio receiver, a radio transmitter, signal drivers, clock circuits, power source circuits, and user input devices. As such, these functions may be interpreted as steps of a method to perform filtering of interference signals in a broadband over power line system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

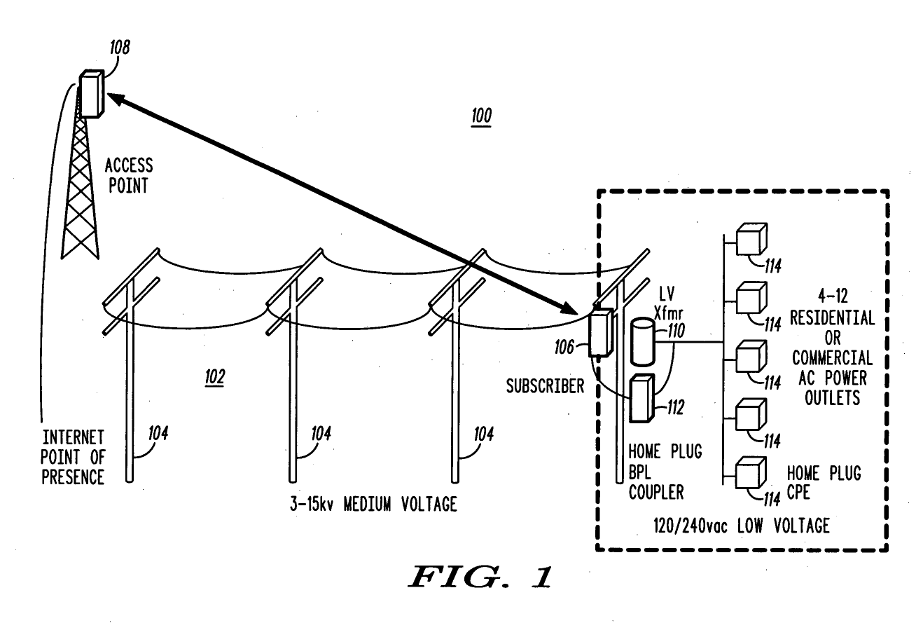

Referring to FIG. 1, an illustration of the broadband over power line system (BPL) 100 is shown. BPL system 100 includes a power line system 102 that is commonly used in supplying power to residential and commercial properties. Typically, power line system 102 supplies residential and commercial properties with 3 to 15 kilovolts of medium voltage that is transformed to power electrically powered devices (not shown) used including household appliances and computer equipment. BPL systems are known that use repeaters (not shown) periodically mounted on utility power poles 104 to relay the Internet signals from the point of origin to the location where a bridge located.

In the present invention, a wireless technology comprised of an access point 105 and subscriber 106 are used to promulgate the Internet signals of the BPL system 100 from the point of origin to the bridge 112 (labeled as BPL Coupler) on power pole 104. Bridge 112 is attached to power pole 104 such that bridge 112 generates the OFDM signal for use by at least one of a plurality of clients 114 that can reside in the residential or commercial property. OFDM distributes data over a number of different carriers. The implementation of OFDM often relies on very high speed digital signal processing that is now available and becoming more prevalent. In at least one embodiment, OFDM takes a carrier and modulates it using Quadrature Phase Shift Keying (QPSK), which is known in the art. The OFDM system can be any of known OFDM systems presently available, the one using the HomePlug standard utilized and provided by Motorola, Inc.

Referring still to FIG. 1, BPL system 100 includes a bridge 112 that receives the Ethernet signal from an Internet point of presence 108, through access point 105, through subscriber 106, to client 114, thereby avoiding the need to have repeaters (not shown), which are used by other BPL systems. A subscriber 106 and bridge 112 are positioned near a low voltage transformer 110 and provides 120/240 vac power to subscriber 106 and bridge 112. BPL coupler or bridge 112 can be one of the many sorts of couplers used in BPL systems 100 that convert the signal received from the point of origin 105 for use by the client 114. BPL coupler 112 can be configured to operate under the HomePlug protocol. The low voltage transformer 110 provides 120/240 vac power to clients 114 that can be coupled to a number of residential or commercial AC power outlets.

In view of the forgoing, BPL system 100 provides an Internet signal from a point of presence 108 to a client 114. The Internet signal is sent to the bridge 112 using Motorola Canopy technology by Ethernet. The bridge produces an OFDM signal from the Ethernet signal that is able to be used by the BPL coupler which supplies the Internet signal to the AC power outlets of the residential and commercial locations thereby connecting them to the Internet. In each of the power outlets, users connect their clients, or consumer premise equipment, 114 so that the user can connect to and use the Internet.

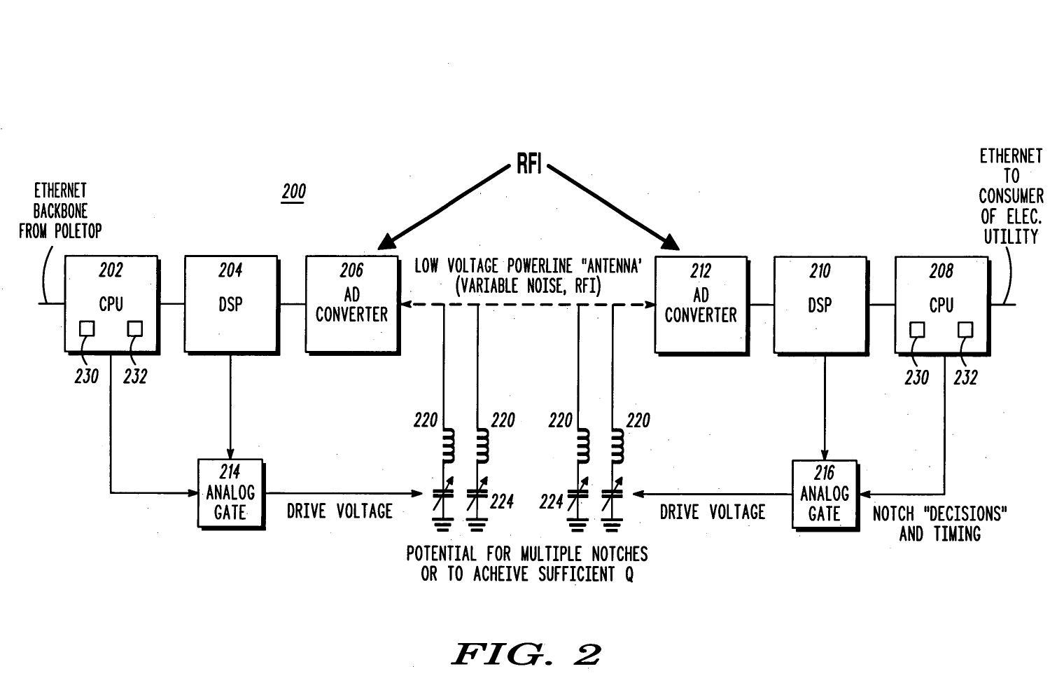

Turning to FIG. 2, a BPL system 200 is shown. As is known, the BPL system 200 provides an Internet connection between an Internet access point 106 and a client 114, where the client can be an connected to a consumer of an electric utility. The access point 106 is coupled to a computer processing unit (CPU) 202 at the bridge. The CPU 202 is coupled to a digital signal processor (DSP) 204 that is in turn coupled to an analog/digital (A/D) converter 206. The CPU 202, DSP 204 and A/D converter 206 are all known in the art and are used to provide a connection between the Internet access point 106 and the client 114. Similar to the connection from the access point 106, the client 114 is coupled to a CPU 208. The CPU 208 is coupled to a DSP 210, and the DSP 210 is coupled to an A/D converter 212. The CPU 208, DSP 210 and the A/D converter 212 provide the connection between the client 114 and the Internet access point 106.

The DSPs 204, 210 are coupled to an analog gate 214, 216, respectively. In addition, the CPUs 202, 208 are coupled to the analog gates 214, 216, respectively. The analog gates 214, 216 drive voltage for the BPL system 200. The analog gates would provide the function of inserting or bypassing the adaptive notch filter (discussed below) from the circuit so that maximum Internet bandwidth could be delivered without the presence of interfering signals and the adaptive notch filter could be automatically inserted to remove interference in the presence of interfering signals.

The A/D converters 206, 212 are configured to do digital filtering, but they are not protected from strong signal radio frequency interference. The strong signal RFI can be created by a number of sources including from users within the 1.7-80 MHz spectrum. Users in this spectrum are mostly users of amateur radio, citizen band radio and lowband frequency modulation. These signals can produce disruptive interference signals to the BPL system 100, 200 with perhaps as little as 40 watts from half a mile away.

The OFDM connection typically operates within the 4 to 21 MHz range, which is in the range capable of the being filtered by the A/D converters 206, 212. As mentioned, operators in this frequency range attempt to reduce all interferences that are generated by a system such as a BPL system. In addition to avoiding generating interference signals, interference signals are received from other sources, e.g. the power lines acting as an antenna that can affect the signal of the BPL system. In order to reduce the interference signals generated and received by the BPL system, multiple filters 220 are provided. Filters 220 can be of any sort of known filters. In light of the frequency ranges and power levels it has been determined that notch filters in their various configurations should be chosen.

As seen in FIG. 2, filters 220 are coupled between the A/D converter 206 connected on the access point side of the BPL system and the A/D converter 212 connected on the client side of the BPL system. In addition, the filters 220 are connected between the analog gate 214 on the access point side of the BPL system and the analog gate 216 on the client side of the BPL system. Filters 220 are configured for fixed and variable noise filtering and for the radio frequency interference that may be generated or received by the BPL system. Such noise and interference can be generated by the BPL system and sent to other radio frequency systems or received from such radio frequency systems.

The DSPs 204, 210 calculate the signal to noise ratio for each OFDM carrier by monitoring and testing the information generated by the OFDM system or use an Automatic Level Control (not shown) circuit to determine maximum signal levels. Such automatic level control circuits are known by those skilled in the art. From these calculations, the filters 220 can be appropriately configured according to the principles of the present invention. The DSPs 204, 210 also monitoring for high or sudden analog voltages that are received from the A/D converters 206, 212 by monitoring for these voltages, the DSPs operate to configure the filters 220.

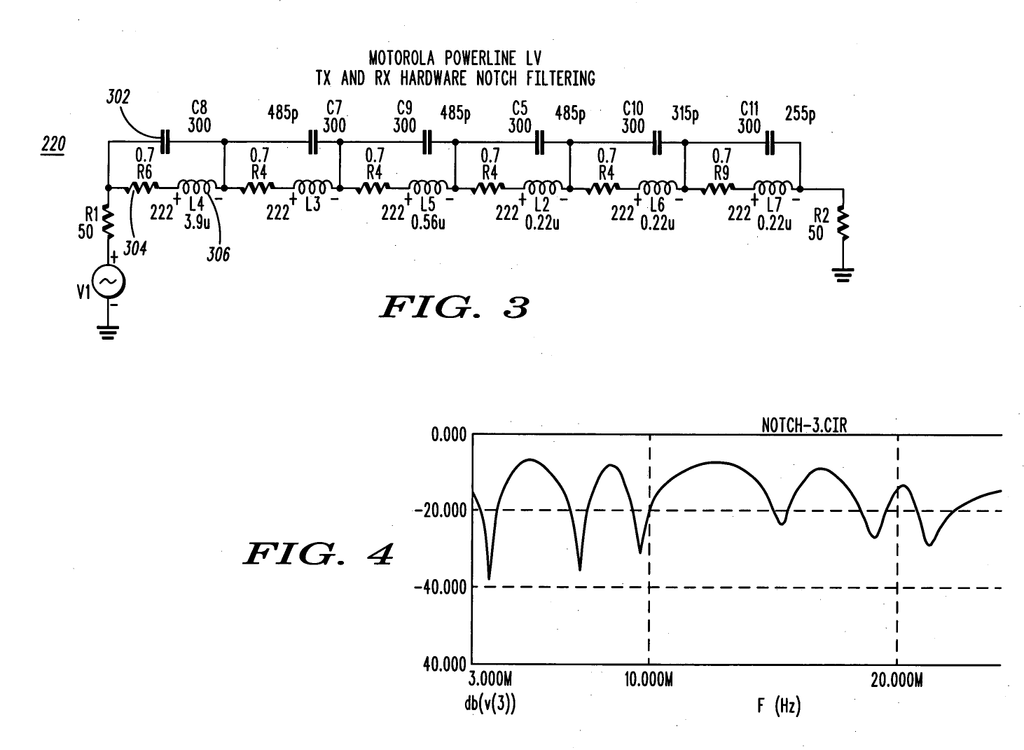

As stated, the filters 220 are notch filters. In the relevant frequency ranges, there are known frequencies that can cause interferences that are received by the BPL system. These known frequencies can be generated by those frequency ranges within the 4-21 MHz range that are used by amateur radio, public service providers and other such services. There are numerous such ranges within the relevant frequency ranges for the BPL systems that reduce the available bandwidth. For these known frequencies, fixed notch filters (discussed below in FIG. 3) or tunable notch filters operate to filter out the interference they cause to the BPL system. For other interference signals that can be caused by, for example, the power lines, adaptive notch filters 224 can be used. Adaptive notch filters 224 or tunable notch filters are configured to adjust to the found interference signals. Once an interference signal is determined, then the adaptive notch filter adjusts its range to the frequency of the interference signal to filter out the interference.

The number of notch filters 220 can vary depending on the circumstances. For those known interference signals, it is appropriate to provide the number of fixed notch filters that correspond to the known number of interference signals. For the interference signals with unknown frequency values, a suitable number of adaptive notch filters 224 are provided that correspond to a reasonable number of unknown interference signals that can be expected to be received by the BPL system. It is expected that at least two adaptive notch filters 224 will be present. Because of the multiple octaves of frequency involved, there may be multiple filters to maintain tuning voltage ranges and optimum Q value.

For the interference signals that are generated by the BPL system, the number of notch filters 220 can also vary depending on the circumstances. For those known interference signals generated by the system, it is appropriate to provide a number of fixed notch filters 222 that correspond to the known number of interference signals that are generated by the system. For the interference signals generated by the BPL system that are not known, a given number of adaptive notch filters 224 can be provided.

As can be appreciated by one of ordinary skill in the art, the present invention provides a BPL system 100 that operates at full bandwidth and that will adapt to interference signals if and when they occur. If an RF signal is detected or is very strong in comparison to existing received signals, the adaptive notch filters described can be used to reduce the signals. A programmable threshold 230, which operates from the CPUs 202, 208, can be used within the BPL so that certain levels of interference will be detected and filtered while other interference signals will not be affected. The programmable threshold 230 is associated with the adaptive notch filters to control the range of the frequencies that that will be filtered. The system operator can predetermine or remotely adjust the threshold values which can be updated in the CPU 202 by over the air programming or direct Ethernet connections. The programmable threshold 230 can also send a command through the BPL system so that one or more notch filters at desired frequencies can be inserted at the appropriate place in the system.

The BPL system described herein can also include a programmable timer 232, which also operates from the CPUs 202, 208. The programmable timer is configured to operate with the adaptive notch filters 224. As described, the adaptive notch filters 224 can be set within a range of frequencies to reduce an interference signal received or generated by the BPL system. The programmable timer 232 can be set for a certain period of time. When the timer 232 expires, it deactivates the adaptive notch filter so that the filter can be bypassed if a different interference signal is detected. As can be appreciated by those skilled in the art, interference signals detected by the system will not be maintained indefinitely. The timer 232 therefore allows the adaptive notch filters 224 to be used more than once.

FIG. 3 illustrates a transmit and receive hardware notch filter 300. As seen the filter 300 is made of a series of notch filters 220, although it should be understood that any number of notches can be used. A notch is made up of a capacitor 302 that is in parallel to a series combination of a resistor 304 (the series resistance of the inductor) and an inductor 306. The first notch 220 in the series is connected to a power source 308 in series with a load resistance 310, and last notch 300 in the series is connected to ground 312 in series with load resistance 314.

FIG. 4 shows a typical transmission response of a filter 300 versus frequency of the source 308.

Since both ends of the OFDM link are located fairly close to each other, they will both generate and receive similar interference. Therefore if an adaptive notch filter is inserted in cascade with one end of the link, the information is communicated to the opposite end of the OFDM link to insert an adaptive notch filter on the same frequency. At the same time the associated OFDM carrier is turned off on both ends of the OFDM link until the timer 232 has timed out.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A filter for a broadband over power line communication systems comprising:
a first filter for reducing known interference signals in the system, and
a second filter for reducing unknown interference signals in the system wherein the second filter adjusts to a determined unknown interference signal.

2. The filter according to claim 1 wherein the first filter is a fixed notch filter.

3. The filter according to claim 1 wherein the second filter is an adaptive notch filter.

4. The filter according to claim 1 wherein the first or second filter filters interference signals generated by the system.

5. The filter according to claim 1 wherein the first or second filter filters interference signals received by the system.

6. The filter according to claim 1 wherein the system is an OFDM system.

7. The filter according to claim 1 wherein the first or second filter detects interference by using OFDM information.

8. The filter according to claim 1 wherein the first or second filter detects interference by using an automatic gain control circuit.

9. The filter according to claim 1 wherein the first or second filter utilizes multiple notches for sufficient notch filtering of interference signals.

10. The filter according to claim 1 further comprising a programmable timer to disable the second filter after a specified period of time.

11. The filter according to claim 1 further comprising a third filter activated by sending a command to the opposite end of the OFDM link.

12. A filter for a broadband over power line communications system comprising
a first filter for reducing interference generated by the system, and
a second filter for reducing interference received by the system.

13. The filter according to claim 12 wherein the first or second filter includes a fixed notch filter,

14. The filter according to claim 12 wherein the first or second filter includes an adaptive notch filter.

15. The filter according to claim 12 wherein the first filter includes a filter for known interference signals generated by the system.

16. The filter according to claim 12 wherein the first filter includes a filter for unknown interference signals generated by the system.

17. The filter according to claim 12 wherein the second filter includes a filter for known interference signals received by the system.

18. The filter according to claim 12 wherein the second filter includes a filter for unknown interference signals received by the system.

19. The filter according to claim 12 wherein the system is an OFDM system.

20. The filter according to claim 12 wherein the first or second filter detects interference signals by using OFDM information

21. The filter according to claim 12 wherein the first or second filter detects interference signals by an automatic gain control circuit.

22. The filter according to claim 12 wherein the first or second filter utilizes multiple notches for sufficient notch filtering of interference signals.

23. The filter according to claim 12 wherein the first or second filter uses available notch performance so that adaptive thresholds of the filter are not used

24. The filter according to claim 12 further comprising a programmable timer to disable an adaptive filter after a specified time.

25. The filter according to claim 12 further comprising a third filter activated by sending a command to the opposite end of the OFDM link.

26. A filter for use in a broadband over power line communication system comprising:
a first filter in a bridge of the system, and
a second filter in a client of the system
wherein the first and second filter reduce interference in the system.

27. The filter according to claim 26 wherein the first or second filter includes a fixed notch filter.

28. The filter according to claim 26 wherein the first or second filter includes an adaptive notch filter.

29. The filter according to claim 26 wherein the first filter includes a filter for known interference signals generated by the system.

30. The filter according to claim 26 wherein the first filter includes a filter for unknown interference signals generated by the system.

31. The filter according to claim 26 wherein the second filter includes a filter for known interference signals received by the system.

32. The filter according to claim 26 wherein the second filter includes a filter for unknown interference signals received by the system.

33. The filter according to claim 26 wherein the first or second filter reduces interference generated by the system.

34. The filter according to claim 26 wherein the first or second filter reduces interference received by the system.

35. The filter according to claim 26 wherein the system is an OFDM system.

36. The filter according to claim 26 wherein the first or second filter detects interference signals by using OFDM information

37. The filter according to claim 26 wherein the first or second filter detects interference signals by using an automatic gain control circuit.

38. The filter according to claim 26 wherein the first or second filter utilizes multiple notches for sufficient notch filtering of interference signals.

39. The filter according to claim 26 further comprising a programmable timer to disable an adaptive filter after a specified time.

40. The filter according to claim 24 further comprising a third filter activated by sending a command to the opposite end of the OFDM link.
